(19) United States
(12) Patent Application Publication
(10) Pub. No.: US 2019/0034865 A1
(43) Pub. Date: Jan. 31, 2019

(54) COMPUTER IMPLEMENTED SYSTEM AND METHOD FOR ESTIMATING RELOCATION COST

(71) Applicant: Vivek Marolli, Mumbai (IN)

(72) Inventor: Vivek Marolli, Mumbai (IN)

(21) Appl. No.: 16/045,374

(22) Filed: Jul. 25, 2018

Related U.S. Application Data
(60) Provisional application No. 62/536,967, filed on Jul. 25, 2017.

(51) Int. Cl. G06Q 10/08; G06F 17/30; G06F 3/0482; G06Q 30/02; G06Q 50/30

(52) U.S. Cl. CPC G06Q 10/087; G06F 17/30398; G06Q 50/30; G06Q 30/0206; G06F 3/0482

(57) ABSTRACT

Methods, systems, and computer program products for estimating an inventory volume and a corresponding range of a number of items for facilitating relocation. The system includes one or more processors and a memory coupled to the processors. The memory stores data comprising program code that, when executed by the processors, causes the system to retrieve and validate a quantum of the inventory volume and the corresponding range of the number of items from a database against one or more future user selections. If validated, the computer assigns the quantum of the inventory volume and the corresponding range of the number of items for at least one group including relocation parameters similar to a relocation origin and at least one relocation type correlated to the quantum of the inventory volume and the corresponding range of the number of items.

### TECHNICAL FIELD

The present invention relates generally to relocation management, and particularly to a method and system for estimating cost of relocation of home/office inventories using measurements of one or more objects.

### BACKGROUND

Conventionally, relocating personal or official inventories can be a complicated, time consuming and expensive process regardless of whether it may occur within a local area or across a longer distance. Relocating either home or office is also one of the biggest causes of stress. Further, the agony of relocating begins way before the actual move and it may become worse if the relocating process is not handled properly.

The relocating process may require several types of services such as packers, haulers or transporters or movers and temporary storage services in which each service provider may require prolonged telephone conversations and/or inspections in order to generate a quote for a specific service. For example, a packing and hauling service provider may have to visit a home or office premises in order to inspect the objects to be relocated. Such service providers typically provide quotes/charges based on the number of objects to be relocated, the size and/or weight of the relocated objects, and the total labor time or mileage distance between the individual's current and future home or office premises. Traditionally, one or more representatives of the service providers may schedule an in-person visit to a customer's home or office premises to count, identify, measure, and/or classify the objects being relocated to estimate a time and/or cost for the relocation. Despite the expertise of the representatives of the service providers, generating an accurate quote for relocation remains a challenge to such service providers.

With the advent of technology, the need of a physical visit to inspect the objects to be relocated at the home or office premises was replaced with online services provided by the service providers. While doing so, some service providers have tried to simplify the complete quotation process by asking the customers to fill out online surveys or questionnaires themselves so that relevant relocation information may be received by the service providers. However, most of the time, these online surveys are simply lead generation forms in which the service providers subsequently contact the customer to set up an inspection and provide an estimated quote for the relocation. Furthermore, these online surveys are a cumbersome process and required vast customer time to complete these surveys. Another limitation with these online surveys is that there may be objects in the home or office premises that do not find an exact or approximate match in the library of surveys. All these limitations lead to inaccurate calculation of volume in the survey process which result in inaccurate quotes to customers.

Therefore, the present disclosure focuses on reducing the burden on the customer and be able to arrive at the home/office inventory calculations without hassle.

Thus, there is a need for methods and systems for estimating cost of relocation of home/office inventories using measurements of one or more objects.

### SUMMARY

According to an embodiment of the invention, a method is provided of estimating an inventory volume and a corresponding range of a number of items for facilitating relocation. A computer retrieves a quantum of the inventory volume and the corresponding range of the number of items from a database. The quantum of the inventory volume and the corresponding range of the number of items correlate to a relocation origin and at least one relocation type. The computer validates the quantum of the inventory volume and the corresponding range of the number of items against one or more future user selections. The one or more future user selections are associated with at least one of an actual range of the number of items and an actual quantum of the inventory volume. If validated, the computer assigns the quantum of the inventory volume and the corresponding range of the number of items for at least one group including relocation parameters similar to the relocation origin and the at least one relocation type. If not validated, the computer updates the quantum of the inventory volume and the corresponding range of the number of items in the database for the at least one group. In some embodiments, the computer generates a user interface indicative of the at least one relocation type; the at least one relocation type may be based on at least one of the relocation origin and the quantum of the inventory volume. In embodiments, the computer may receive the one or more future user selections associated with the at least one relocation type on the user interface.

In embodiments, the computer retrieves the quantum of the inventory volume and the corresponding range of the number of items from the database based on identifying a user from the at least one group. In some embodiments, the quantum of the inventory volume and the corresponding range of the number of items are correlated to the relocation origin and a relocation area.

In embodiments, the computer generates a first graphical user interface including a mapping of a predictive relocation area. The predictive relocation area may be indicative of the quantum of the inventory volume and the corresponding range of the number of items, and the predictive relocation area may be based on the at least one relocation type. Moreover, the predictive relocation area may be based on the relocation origin. In embodiments, the computer receives the one or more future user selections on the first graphical user interface. Furthermore, the one or more future user selections may be associated with one or more of an actual number of items, the actual quantum of the inventory volume, an actual relocation area, the relocation origin, a type of the relocation origin, and the at least one relocation type. Is some embodiments, the computer validates the predictive relocation area against the one or more future user selections associated with the actual relocation area. If validated, the computer may assign the predictive relocation area as a relocation area for the at least one group in the database. If not validated, the computer updates the predictive relocation area for the at least one group in the database.

In embodiments, the computer generates a second graphical user interface indicative of the relocation area. One or more relocation types may correspond to the relocation area, the quantum of the inventory volume, and the corresponding range of the number of items mapped to each of the one or more relocation types. The second graphical user interface may be configured to receive the one or more future user selections and the one or more future user selections may be associated with one or more of an actual relocation area, a type of relocation, a type of the relocation origin, the actual range of the number of items, and the actual quantum of the inventory volume. In some embodiments, the relocation parameters of the at least one group may include at least one of a type of the relocation origin, a type of relocation, the relocation area; and the quantum of the inventory volume.

In embodiments, the quantum of the inventory volume, the corresponding range of the number of items correlating to the relocation origin, and the at least one relocation type may be based on a corresponding correlation factor. Moreover, the updating of the quantum of the inventory volume and the corresponding range of the number of items in the database for the at least one group may include updating the corresponding correlation factor to a new correlation factor.

In some embodiments, the predictive relocation area is indicative of the quantum of the inventory volume, the corresponding range of the number of items is based on a corresponding correlation factor, and updating the predictive relocation area for the at least one group in the database includes updating the corresponding correlation factor to a new correlation factor. Moreover, updating the corresponding correlation factor to the new correlation factor may be based on exceeding a threshold number of the one or more future user selections.

In another embodiment of the invention, a system may be provided. The system may include a processor and a memory storing instructions that, when executed by the processor, may cause the system to estimate an inventory volume and a corresponding range of a number of items for facilitating relocation. The system may be configured to retrieve a quantum of the inventory volume and the corresponding range of the number of items from a database. The quantum of the inventory volume and the corresponding range of the number of items may correlate to a relocation origin and at least one relocation type. The system may also be configured to validate the quantum of the inventory volume and the corresponding range of the number of items against one or more future user selections. The one or more future user selections may be associated with at least one of an actual range of the number of items and an actual quantum of the inventory volume. If validated, the system may be configured to assign the quantum of the inventory volume and the corresponding range of the number of items for at least one group including relocation parameters similar to the relocation origin and the at least one relocation type. If not validated, the system may be configured to update the quantum of the inventory volume and the corresponding range of the number of items in the database for the at least one group.

In some embodiments, the system may be configured to estimate the quantum of the inventory volume and the corresponding range of the number of items based on a correlation factor corresponding to the relocation origin and the at least one relocation type. The estimated quantum of the inventory volume and the estimated corresponding range of the number of items may be stored in the database. Moreover, updating the quantum of the inventory volume and the corresponding range of the number of items in the database for the at least one group may include updating the correlation factor to a new correlation factor. In embodiments, the quantum of the inventory volume and the corresponding range of the number of items may be correlated to the relocation origin and a relocation area. Furthermore, the estimated corresponding range of the number of items may correspond to the relocation origin and the relocation area.

In embodiments, the system may be configured to identify a user from the at least one group and retrieve the quantum of the inventory volume and the corresponding range of the number of items for the at least one group from the database.

The above summary may present a simplified overview of some embodiments of the invention in order to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### OBJECTS

Some of the objects of the present disclosure aim to ameliorate one or more problems of the prior art or to at least provide a useful alternative as listed herein below.

An object of the present disclosure is to provide a computer implemented system for estimating cost of relocation of home/office inventories using measurements of one or more objects.

Another object of the present disclosure is to provide a computer implemented method for estimating cost of relocation of home/office inventories using measurements of one or more objects.

Another object of the present disclosure is to provide a computer implemented method to reduce the burden to the customer and be able to arrive at the home/office inventories calculation without too much hassle.

Another object of the present disclosure is to provide the home/office inventories calculation in the unit of volume, preferably in cubic feet, which may be converted into weight, for example, in pounds.

Other objects and advantages of the present disclosure will be more apparent from the following description when read in conjunction with the accompanying figures, which are not intended to limit the scope of the present disclosure.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and modules.

FIG. 1A illustrates an exemplary user interface 110 of a computer implemented system to capture the information related to distance of relocation by inputting the place of origin and destination, according to an exemplary implementation of the present disclosure.

FIG. 1B illustrates an exemplary user interface 120 of a computer implemented system to capture the information related to type of relocation which is provided in drop-down menu of said user interface, according to an exemplary implementation of the present disclosure.

FIG. 1C illustrates an exemplary user interface 130 of a computer implemented system to capture the information related to carpet area (in Sq. Ft.) of the present premises, according to an exemplary implementation of the present disclosure.

FIG. 1D illustrates an exemplary user interface 140 of a computer implemented system to capture the information related to number of quantum of items or articles in the home/office premises, such as furniture and boxes, required to be relocated which is provided in slider menu of said user interface, according to an exemplary implementation of the present disclosure.

FIG. 2 illustrates an exemplary computer implemented system 200 for estimating cost of relocation of home/office inventories using measurements of one or more objects, according to an exemplary implementation of the present disclosure.

FIG. 3 illustrates a Table 1 as an exemplary grid 300 representing the fixed values of indicative number of furniture plus boxes that may be displayed to the user/customer based on their selection criteria, according to an exemplary implementation of the present disclosure.

It should be appreciated by those skilled in the art that any block diagrams herein represent conceptual views of illustrative systems embodying the principles of the present disclosure. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

In the following detailed description of the embodiments of the present disclosure, numerous specific details are set forth in order to provide a thorough understanding of the embodiments of the invention. However, it will be obvious to one skilled in the art that the embodiments of the invention may be practiced without these specific details. In other instances well known methods, procedures, components, and circuits have not been described in detail so as not to unnecessarily obscure aspects of the embodiments of the invention.

References in the present disclosure to “one embodiment” or “an embodiment” mean that a particular feature, structure, characteristic, or function described in connection with the embodiment is included in at least one embodiment of the invention. The appearances of the phrase “in one embodiment” in various places in the present disclosure are not necessarily all referring to the same embodiment.

The embodiments of the invention include a method and system for estimating cost of relocation of home/office inventories using measurements of one or more objects. In this context, the present invention disclosure provides a plurality of user interfaces through which an operator or a user himself inputs data related to a relocation process. In details, the data inputted by the user includes origin city and destination city of the move, type of move, carpet's square feet area of the house or office premises, indication of how much furniture plus boxes to be moved, is there in the premises. Further for better clarity, the above-mentioned input data, of how much furniture plus boxes is there to be moved, may be provided in the form of a slider, on the user interface, that the customer may use to select one of five options, for example, very light, light, medium, packed and fully packed. Each of these options will trigger a corresponding value from a list of quantum of inventory classification options which is configured in the database of the present computer implemented system.

Further, as mentioned above, the users/customers, input their requirement and the same information is used by the present system to estimate the inventories' volume in the house or office premises using a plurality of correlation factors. Furthermore, the system estimate of the inventories' volume is then validated against the actual inventories' volume in the house or office premises. There may be a possibility of a delta difference between the system estimated inventories' volume and the actual inventories' volume in the house or office premises input by the user. The delta difference between the two is then used to back calculate the correlation factor which may be referred as a new correlation factor. In this respect, at every time, there is a delta difference, and each time it is continuously used to back calculate the correlation factor and the same gets corrected over a period of time over large volumes of input data from a plurality of users/customers who use the system of the present disclosure. However, the correlation factor correction which is done by comparing the delta difference may be done by comparing data in comparable and similar ‘like groups’.

In the present embodiment, the present disclosure provides a plurality of classifications or parameters which, when combined together, build one or more ‘Like Groups’. These parameters are city type classification, type of move, carpet square feet area (in Sq. Ft.) clusters and quantum of inventory classification (QOIC). The city type classification may be simplified by providing a further classification of cities in any county. For example, all cities in any country may be classified into these five types, such as metro city, big city, small city, big town and small town. Further, the type of move can be of 3 types viz. Move with only personal effects, Move with part furniture and Move with full furniture. Further, the carpet Sq. Ft. area clusters may be simply Sq. Ft. area ranges in fixed intervals such as 250 Sq. Ft., therefore, when the user/customer inputs the carpet Sq. Ft. area, the system puts it into an appropriate clusters. Furthermore, the quantum of inventory classification provides a method to quantify the volume of inventories in the premises. In this context, the present disclosure provides one or more list of QOIC values such as ‘Really Light’, ‘Light’, ‘Medium’, ‘Full’, and ‘Over Packed’. And these options vary for each of the three types of moves specified above.

In another embodiment, the present disclosure provides a method to calculate the occupied Sq. Ft. area of the premises. The occupied Sq. Ft. area may be defined as a measure of how much area in the premises, carpet Sq. Ft. area, is occupied by various inventories such as furniture and the like. Further, the occupied Sq. Ft. area of the premises may be calculated by applying the appropriate correlation factor. To this end, the present disclosure provides one or more correlation factors for each of the QOIC values. As provided above each of the ‘Like Group’ comprising city type classification, type of move, carpet Sq. Ft. cluster and quantum of inventory classification (QOIC) and its associated QOIC value for each type of move, there may be a corresponding correlation factor. For example, for five QOIC Values (Really Light, Light, Medium, Packed and Fully Packed) there will be five sets of correlation factors corresponding to each QOIC Value in every ‘Like Group’. Initially, the default values may be configured for each of the correlation factors such as 40% for ‘Really Light’, 55% for ‘Light’, 70% for ‘Medium’, 80% for ‘Packed’, and 100% for ‘Fully Packed’ QOIC values.

Furthermore, by applying theses correlation factors, the system calculates occupied Sq. Ft. area of the premises. For example, a carpet Sq. Ft. area may be 1345 Sq. Ft. and the QOIC value as determine by the system is ‘Medium’, i.e. 70%, therefore, with these values, the system calculates the occupied Sq. Ft. area of the premises as 1345×70% which is calculated as 941.5 Sq. Ft. which is the calculated occupied Sq. Ft. area of the premises. One important observation is that the present calculated occupied Sq. Ft. area of the premises is based on the default correlation factor. Over the period of time, there may be correction in the correlation factors by which the occupied Sq. Ft. area is calculated by the present system may get closer to accuracy.

In another embodiment, the present disclosure provides a method to calculate inventory volume. Once the occupied Sq. Ft. area of the premises is accurately determined, the system proceeds towards calculating the inventories volume. In the process, a ‘Fixed Conversion Factor’ may be used to convert the occupied Sq. Ft. area into inventory volume (in Cu. Ft). Once the inventory volume is determined another ‘Fixed Conversion Factor’ is used to convert inventory volume (Cu.ft) into Inventory Weight (in Pounds).

In another embodiment, the present disclosure provides a mechanism of machine learning process which corrects the correlation factors within the ‘Like Groups’ over a period of time. In this context, various corrections in the correlation factors, as discussed above, for each ‘Like Groups’ may be recorded in the system and once the threshold number of relocation entries is crossed, the new correlation factor may be averaged out to arrive at the new correlation factor for each ‘Like Groups’. Further, the delta deviation from the default correlation values may also be calculated. Consequently, the new correlation factor for the particular ‘Like Groups’ is replaced. In this way, the present disclosure directed towards a system which may generate a close to perfect quote for a particular type of relocation over a period of time.

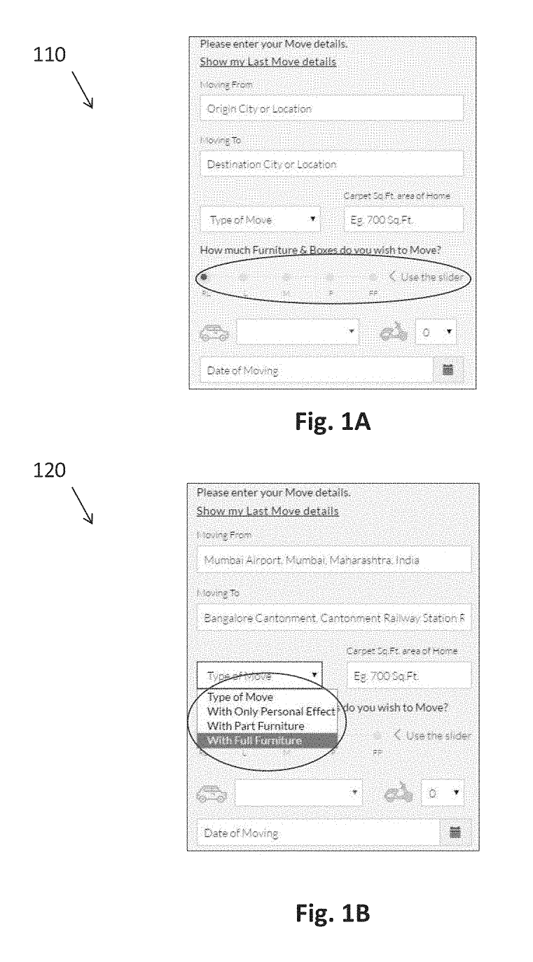

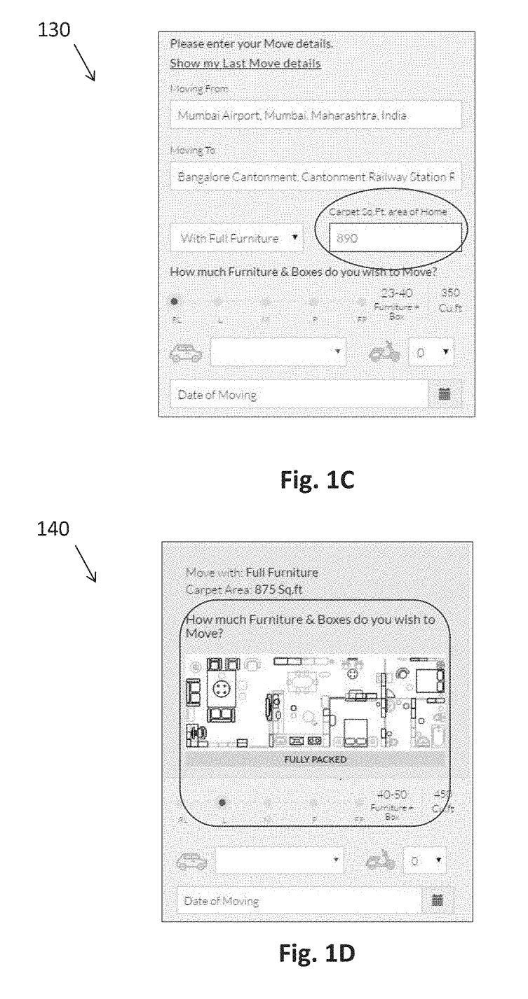

FIG. 1A illustrates an exemplary user interface 110 of a computer implemented system to capture the information related to distance of relocation by inputting the place of origin and destination, according to an exemplary implementation of the present disclosure.

Further, the user interface 110 provides the option of inputting origin city of relocation, destination city of relocation along with a slider to select a QOIC value. The calculated Cu. Ft. value may be displayed on the user interface. Additionally, as per the user interface 110, as users/customers may not relate or understand to the Cu. Ft. numbers, therefore, the user interface may display an indicative number such as range of numbers of furniture plus boxes that the said relocation may supposedly entail.

FIG. 1B illustrates an exemplary user interface 120 of a computer implemented system to capture the information related to type of move which is provided in drop-down menu of said user interface, according to an exemplary implementation of the present disclosure.

Further, the user interface 110 provides the information pertaining to the types of move. As provided in the user interface, there are plurality of types of moves provided to the user/customers. The types of moves may be move with only personal effects, move with part furniture and move with full furniture. The present system applies the correlation factor for each of the above move separately and may handle various parallel activities. Further, the data available within the ‘Like Groups’ may be then compared for these different types of moves. For example, the comparison may be in line with the city classification, carpet Sq. Ft. classification and the QOIC value. Thereafter, the relation between the different types of moves may be computed.

In an example, if one assumes that ‘Move with Full Furniture’ is 100%, then ‘Move with Part Furniture’ may be 80% of ‘Move with Full Furniture’ and ‘Move with Personal Effects’ can be 60% of the ‘Move with Full Furniture’. Therefore, this relation % data may be used to further strengthen the correlation factors.

FIG. 1C illustrates an exemplary user interface 130 of a computer implemented system to capture the information related to required area, such as carpet area, (in Sq. Ft.) of the present premises, according to an exemplary implementation of the present disclosure. The carpet area in Sq. Ft. is takes into consideration the value selected for ‘Type of Move’. For example, the user interface 130 provide if the ‘Type of Move’ is selected as ‘Move with Full Furniture’ then carpet Sq. Ft. area of the premises may provide a differ value in the next step as compared to if a different value is selected for ‘Type of Move’.

FIG. 1D illustrates an exemplary user interface 140 of a computer implemented system to capture the information related to number of items/articles, such as Furniture plus Boxes, required to be relocate which is provided in the form of a Typical floor plan with Furniture and Boxes depicted on the plan and a slider menu of said user interface, according to an exemplary implementation of the present disclosure. Depending on the value selected in ‘Type of Move’ a different floor plan is displayed. For example, in the present user interface 140, the ‘Type of Move’ is selected as ‘Move with Full Furniture’ accordingly user may see a floor plan of an empty space and can use the slider to select a value and accordingly the quantum of furniture and boxes increase or decrease in the display interface. For each slider option selected the interface also displays the Cu. Ft volume as calculated by the system. In addition, as users/customers may not relate or understand to the Cu. Ft. volume number as a representation per their move requirements, the interface will also display a rate of furniture plus boxes that the selected options entail giving the customer an indication to provide the most accurate inputs

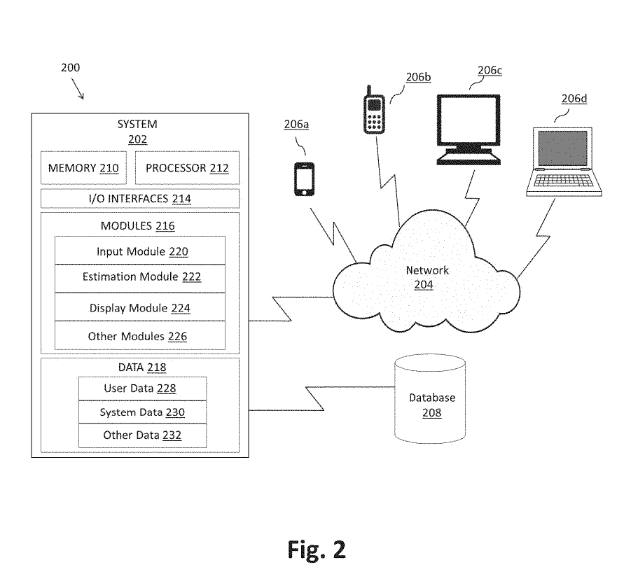

FIG. 2 illustrates an exemplary computer implemented system 200 for estimating cost of relocation of home/office inventories using measurements of one or more objects, according to an exemplary implementation of the present disclosure. The present computer implemented system 200 includes a system (202), a network (204) a plurality of user devices 206 (206a, 206b, 206c, 206d), a database (208), a memory (210), a processor (212), I/O interfaces (214), a plurality of modules (216), and plurality of data (218).

The network (204) interconnects the user devices (206) and the database (208) with the system (202). The network (204) includes wired and wireless networks. Examples of the wired networks include a Wide Area Network (WAN) or a Local Area Network (LAN), a client-server network, a peer-to-peer network, and so forth. Examples of the wireless networks include Wi-Fi, a Global System for Mobile communications (GSM) network, and a General Packet Radio Service (GPRS) network, an enhanced data GSM environment (EDGE) network, 802.5 communication networks, Code Division Multiple Access (CDMA) networks, or Bluetooth networks.

In the present implementation, the database (208) may be implemented as enterprise database, remote database, local database, and the like. The database (208) may be located within the vicinity of the system (202) or may be located at different geographic locations as compared to that of the system (202). Further, the database (208) may themselves be located either within the vicinity of each other, or may be located at different geographic locations. Furthermore, the database (208) may be implemented inside the system (202) and the database (208) may be implemented as a single database or as multiple databases.

In the present implementation, the system (202) includes one or more processors (212). The processor (212) may be implemented as one or more microprocessors, microcomputers, microcontrollers, digital signal processors, central processing units, state machines, logic circuitries, and/or any devices that manipulate signals based on operational instructions. Among other capabilities, the at least one processor (212) is configured to fetch and execute computer-readable instructions stored in the memory (210).

The I/O interfaces (214) may include a variety of software and hardware interfaces, for example, a web interface, a graphical user interface, and the like. The I/O interface (214) may allow the system (202) to interact with a user directly or through the user devices (206). Further, the I/O interface (214) may enable the system (202) to communicate with other user devices or computing devices, such as web servers. The I/O interface (214) can facilitate multiple communications within a wide variety of networks and protocol types, including wired networks, for example, LAN, cable, etc., and wireless networks, such as WLAN, cellular, or satellite. The I/O interface (214) may include one or more ports for connecting a number of devices to one another or to another server.

The memory (210) may be coupled to the processor (212). The memory (210) can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the system (202) includes modules (216). The modules (116) include routines, programs, objects, components, data structures, etc., which perform particular tasks or implement particular abstract data types. In one implementation, the module (216) includes an input module (220), an estimation module (222), a display module (224) and other modules (226). The other modules (226) may include programs or coded instructions that supplement applications and functions of the system (202).

In the present implementation, the input module (220) is configured to set up the multiple user interfaces as explained in above FIGS. 1A-1D. Through these user interfaces, the present system (202) receive inputs from user/customer to calculate final quote for the relocation. In details, the data inputted by the user/customer includes origin city and destination of the move, type of move, carpet's square feet area of the house or office premises, quantum of furniture and boxes to be moved. Further for better clarity, the above-mentioned input data of quantum of furniture and boxes to be moved may be provided in the form of a slider, on the user interface, that the user/customer may use to select one of five options, for example, very light, light, medium, packed and fully packed. Each of these options will trigger a corresponding value from a list of quantum of inventory classification options which is configured in a database (208) of the present system (202).

Further, in the present implementation, the estimation module (222) is configured to estimate the inventories volume corresponding to the customer input data which is then validated against the actual inventories volume in the house or office premises. The estimation module (222) is further configured to detect the delta difference between the system estimated inventories volume and the actual inventories' volume in the house or office premises inputted by the user. The delta difference between the two is then used to back calculate the correlation factor which may be referred as a new correlation factor. In this respect, at every time, there is a delta difference, and each time it is continuously used to back calculate the correlation factor and the same gets corrected over a period of time over large volumes of input data from a plurality of users/customers who use the system (202). Furthermore, in the present implementation, the display module (224) is configured to display the estimated cost of relocation of home/office inventories to the user in the form of quotes.

Further, the system (202) includes data (218). In one implementation, the data (218) includes user data (228), system data (230), and other data (232).

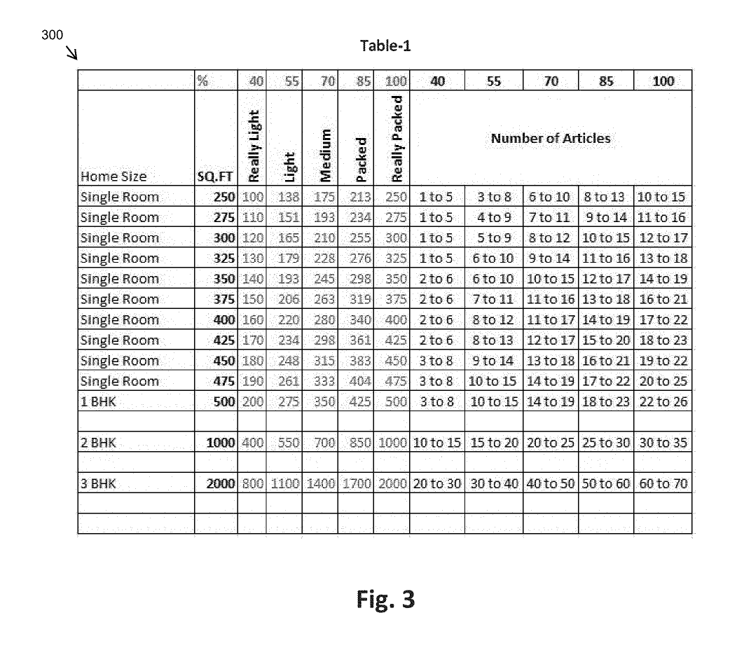

FIG. 3 illustrates a Table 1 as exemplary grid 300 representing the fixed values of indicative number of furniture plus boxes that may be displayed to the user/customer based on their selection criteria, according to an exemplary implementation of the present disclosure.

Further, the grid 300 represents the fixed values of Indicative Number of Furniture+Boxes. This number is a fixed value that is presented to the customer for indicative purposed only (along with the calculated Cu.ft volume). Since, the customer/user may not be able to relate with the Cu.ft (Volume) number, the above will be useful for them to get a sense of the volume of their relocation (Inventory Volume).

The foregoing description of the invention has been set merely to illustrate the invention and is not intended to be limiting. Since modifications of the disclosed embodiments incorporating the scope and substance of the invention may occur to persons skilled in the art, the invention should be construed to include everything within the scope of the disclosure.

What is claimed is:

1. A method for estimating an inventory volume and a corresponding range of a number of items for facilitating relocation, the method comprising:
retrieving, by a computer, a quantum of the inventory volume and the corresponding range of the number of items from a database, the quantum of the inventory volume and the corresponding range of the number of items correlating to a relocation origin and at least one relocation type;
validating, by the computer, the quantum of the inventory volume and the corresponding range of the number of items against one or more future user selections, the one or more future user selections being associated with at least one of an actual range of the number of items and an actual quantum of the inventory volume;
if validated, assigning, by the computer, the quantum of the inventory volume and the corresponding range of the number of items for at least one group including relocation parameters similar to the relocation origin and the at least one relocation type; and
if not validated, updating, by the computer, the quantum of the inventory volume and the corresponding range of the number of items in the database for the at least one group.

2. The method of claim 1 comprising retrieving, by the computer, the quantum of the inventory volume and the corresponding range of the number of items from the database based on identifying a user from the at least one group.

3. The method of claim 1 wherein the quantum of the inventory volume and the corresponding range of the number of items are correlated to the relocation origin and a relocation area.

4. The method of claim 1 comprising generating, by the computer, a first graphical user interface including a mapping of a predictive relocation area, the predictive relocation area being indicative of the quantum of the inventory volume and the corresponding range of the number of items, wherein the predictive relocation area is based on the at least one relocation type.

5. The method of claim 4 wherein the predictive relocation area is based on the relocation origin.

6. The method of claim 5 comprising receiving, by the computer, the one or more future user selections on the first graphical user interface, wherein the one or more future user selections are associated with one or more of an actual number of items, the actual quantum of the inventory volume, an actual relocation area, the relocation origin, a type of the relocation origin, and the at least one relocation type.

7. The method of claim 6 comprising validating, by the computer, the predictive relocation area against the one or more future user selections associated with the actual relocation area, wherein:
if validated, the predictive relocation area is assigned as a relocation area for the at least one group in the database, and
if not validated, the predictive relocation area for the at least one group is updated in the database.

8. The method of claim 1 comprising generating, by the computer, a user interface indicative of the at least one relocation type, wherein the at least one relocation type is based on at least one of the relocation origin and the quantum of the inventory volume.

9. The method of claim 8 comprising receiving, by the computer, the one or more future user selections associated with the at least one relocation type on the user interface.

10. The method of claim 3 comprising generating, by the computer, a second graphical user interface indicative of the relocation area, one or more relocation types corresponding to the relocation area, the quantum of the inventory volume, and the corresponding range of the number of items mapped to each of the one or more relocation types, wherein the second graphical user interface is configured to receive the one or more future user selections and the one or more future user selections are associated with one or more of an actual relocation area, a type of relocation, a type of the relocation origin, the actual range of the number of items, and the actual quantum of the inventory volume.

11. The method of claim 3, wherein the relocation parameters of the at least one group include at least one of a type of the relocation origin, a type of relocation, the relocation area; and the quantum of the inventory volume.

12. The method of claim 1, wherein:
the quantum of the inventory volume, the corresponding range of the number of items correlating to the relocation origin, and the at least one relocation type are based on a corresponding correlation factor, and
the updating of the quantum of the inventory volume and the corresponding range of the number of items in the database for the at least one group includes updating the corresponding correlation factor to a new correlation factor.

13. The method of claim 7, wherein:
the predictive relocation area is indicative of the quantum of the inventory volume,
the corresponding range of the number of items is based on a corresponding correlation factor, and
updating the predictive relocation area for the at least one group in the database includes updating the corresponding correlation factor to a new correlation factor.

14. The method of claim 12 wherein updating the corresponding correlation factor to the new correlation factor is based on exceeding a threshold number of the one or more future user selections.

15. A system for estimating an inventory volume and a corresponding range of a number of items for facilitating relocation, the system comprising:
a processor; and
a memory including instructions that, when executed by the processor, cause the system to:
retrieve a quantum of the inventory volume and the corresponding range of the number of items from a database, the quantum of the inventory volume and the corresponding range of the number of items correlating to a relocation origin and at least one relocation type;
validate the quantum of the inventory volume and the corresponding range of the number of items against one or more future user selections, the one or more future user selections being associated with at least one of an actual range of the number of items and an actual quantum of the inventory volume;
if validated, assign the quantum of the inventory volume and the corresponding range of the number of items for at least one group including relocation parameters similar to the relocation origin and the at least one relocation type; and
if not validated, update the quantum of the inventory volume and the corresponding range of the number of items in the database for the at least one group.

16. The system of claim 15 wherein the instructions are further configured to cause the system to:
estimate the quantum of the inventory volume and the corresponding range of the number of items based on a correlation factor corresponding to the relocation origin and the at least one relocation type, wherein the estimated quantum of the inventory volume and the estimated corresponding range of the number of items are stored in the database.

17. The system of claim 16 wherein updating the quantum of the inventory volume and the corresponding range of the number of items in the database for the at least one group includes updating the correlation factor to a new correlation factor.

18. The system of claim 16 wherein:
the quantum of the inventory volume and the corresponding range of the number of items are correlated to the relocation origin and a relocation area, and
the estimated corresponding range of the number of items correspond to the relocation origin and the relocation area.

19. The system of claim 15 wherein the instructions are further configured to cause the system to:
identify a user from the at least one group; and
retrieve the quantum of the inventory volume and the corresponding range of the number of items for the at least one group from the database.

20. The system of claim 15 wherein the instructions are further configured to cause the system to generate one or more of:
a first graphical user interface including a mapping of a predictive relocation area, wherein:
the first graphical user interface is indicative of the quantum of the inventory volume and the corresponding range of the number of items,
the predictive relocation area is based on the relocation origin and the at least one relocation type,
the first graphical user interface is configured to receive the one or more future user selections, and
the one or more future user selections are associated with one or more of an actual relocation area, the relocation origin, a type of the relocation origin, and a type of relocation;
a user interface indicative of the at least one relocation type, wherein:
the at least one relocation type is based on at least one of the relocation origin and the quantum of the inventory volume, and
the user interface is configured to receive the one or more future user selections associated with the at least one relocation type;
a second graphical user interface, wherein:
the second graphical user interface is indicative of a relocation area, one or more relocation types corresponding to the relocation area, the quantum of the inventory volume, and the corresponding range of the number of items mapped to each of the one or more relocation types, and
the second graphical user interface is configured to receive the one or more future user selections and the one or more future user selections are associated with one or more of the actual relocation area, the type of relocation, the type of the relocation origin, the actual range of the number of items, the actual quantum of the inventory volume, and the one or more relocation types.
